(19) United States
(12) Patent Application Publication
(10) Pub. No.: US 2007/0146119 A1
(43) Pub. Date: Jun. 28, 2007

(54) Door open-close device

(75) Inventors: Kenji Mizushima, Kanagawa-ken (JP); Ryuji Minemura, Kanagawa-ken (JP)

Correspondence Address: NATH & ASSOCIATES, 112 South West Street, Alexandria, VA, 22314, US

(73) Assignee: ALPHA CORPORATION, Kanazawa-ku, Yokohama-shi, Kanagawa (JP)

(21) Appl. No.: 10/577,257

(22) PCT Filed: Oct. 28, 2004
(86) PCT No.: PCT/JP04/16020

§ 371 Date: Apr. 26, 2006

(30) Foreign Application Priority Data
Oct. 30, 2004 (JP) 2003-370224

(51) Int. Cl. B60R 25/00

(52) U.S. Cl. 340/5.72; 340/5.61; 343/788

(57) ABSTRACT

A door open-close device for control of a lock mechanism of a door is housed in a door handle. The door open-close device is provided with a lock switch connected to an external circuit so as to control the external circuit; and an antenna disposed to have a gap toward the lock switch and press down the lock switch at a time of deforming by being grasped by an operator, the antenna including a core portion of a soft magnetic material having flexibility and a conductor wound around the core portion, the conductor being connected to the external circuit so as to communicate with an external portable device.

### TECHNICAL FIELD

The present invention relates to a door open-close device for control of locking and unlocking doors of a vehicle and such, which is operational without a key.

### BACKGROUND ART

There are recently proposed various key-less entry systems which are capable of locking and unlocking doors of vehicles and operational without keys. As a door open-close device for being applied to a vehicle in combination with a key-less entry system, there is proposed what is disclosed in Japanese Unexamined Patent Publication 2003-239599.

The door open-close device in accordance with the above art is provided with a door handle fixed at the exterior of the door and a lock mechanism for locking the door in a closed position. The door handle further has an antenna built in to transmit and receive a radiowave, there by it is configured so that communication means is capable of communicating with a portable device which an operator carries. The door handle has a first lock switch built in and an escutcheon disposed adjacent to the door handle is provided with a second lock switch. When the first lock switch or the second lock switch is operated, a command to start transmission and reception to the portable device is sent from control means to the communication means and either locking or unlocking is carried out depending on a result of the communication. In a condition where the lock means is locked, opening and closing the door is interrupted, though in a condition where the lock means is unlocked, opening and closing the door is permitted.

When the operator is going to get out of a vehicle and lock the door, he carries the portable device, goes out of vehicle, closes the door and operates the second locks witch of the escutcheon Then, as described above, the communication means starts to communicate with the portable device and, when the control means authenticates the portable device by the communication, makes the lock means be in a locked condition. Thereby, one who does not carry the portable device cannot open the door even though he operates the door handle.

When the operator is going to get in the locked vehicle, he carries the portable device and gets a grip on the door handle. Then the first lock switch is operated and hence the communication means transmits a radio wave from the antenna to start communication with the portable device. Then, if the control means authenticates the portable device, the control means makes the lock means be in an unlocked condition. Thereby, the operator comes to be capable of opening the door.

In accordance with the above art, since the operator carrying the portable device can open the door only by operating the door handle without use of a key, the operator can enjoy great convenience.

### DISCLOSURE OF INVENTION

Since the above art requires two switches, namely the first lock switch and the second lock switch, increasing provision of switches and accompanying parts such as cables leads to increase in the number of parts. Moreover, since a space for housing the parts should be provided around the door handle, it leads to increase in size of the parts around the door handle and complication of the structure thereof and wiring.

The present invention has been carried out for the purpose of solving the above problem and is intended for providing an open-close device capable of providing an operator with great convenience though the constitution is simple and compact.

According to an aspect of the present invention, a door open-close device for control of a lock mechanism of a door is housed in a door handle is provided with a lock switch connected to an external circuit so as to control the external circuit; and an antenna disposed to have a gap toward the lock switch and press down the lock switch at a time of deforming by being grasped by an operator, the antenna including a core portion of a soft magnetic material having flexibility and a conductor wound around the core portion, the conductor being connected to the external circuit so as to communicate with an external portable device.

Preferably, the antenna is further provided with a cover handle, which has the core portion and the conductor sealed in, configured to be installed in the door handle,

### BRIEF DESCRIPTION OF DRAWINGS

FIG. 1 is a front view of a door open-close device in accordance with an embodiment of the present invention.

FIG. 2 is a cross sectional view of the door open-close device taken from a II-II line of FIG. 1 in which only an antenna and accompanying parts thereof are shown as an elevational view.

FIG. 3 is a cross sectional view of the door open-close device in accordance with FIG. 2 to show a condition in which a door handle is grasped and a cover handle is bent.

FIG. 4A is a front view of the antenna.

FIG. 4B is a side view of the antenna.

### BEST MODE FOR CARRYING OUT THE INVENTION

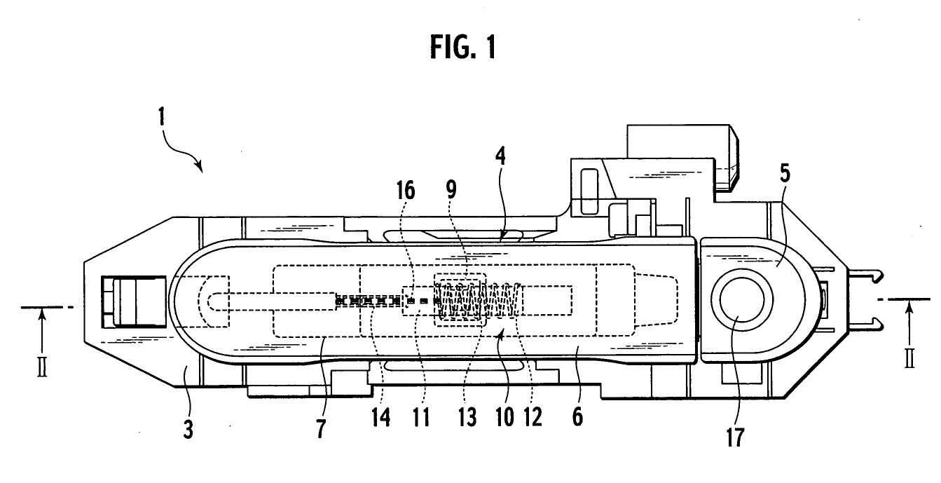

An embodiment of the present invention will be described hereinafter with reference to FIGS. 1 to 4B.

A door open-close device 1 in accordance with an embodiment of the present invention is installed on a door panel 2 of a vehicle to be used and provided with a base member 3 fixed to a rear side of the door panel 2, a door handle 4 pivotally supported by the base member 3 and exposed out of the door panel 2, and an escutcheon 5.

The door handle 4 is provided with a handle main body 5 and a cover handle 7 and has a shape as a whole suitable for an operator to handle by hand. The operator handles and swings the door handle 4 to get the door openable and closable.

The handle main body 6 is pivotally supported by the base member 3 at an end thereof and an opposite end thereof is provided with a lock engaging portion 8 to engage with a lock mechanism (not shown). The lock mechanism is capable of making a transition between a locked condition to interrupt swing of the door handle 4 so that opening and closing of the door are interrupted and an unlocked condition to permit swing of the door handle 4. The transition between the locked condition and the unlocked condition is controlled by control means (not shown). A lock switch 9 to be pressed down is provided in the interior of the handle main body 6 and connected with an electric cable 16. Input information to the lock switch 9 is output to the control means. Details of the control means will be described later.

The cover handle 7 is formed from a flexible resin such as an elastomer resin and is engaged with an engaging portion 6a by using flexible deformation thereof to be installed in the handle main body 6. The cover handle 7 has a predetermined gap to an internal face of the handle main body 6 and the lock switch 9 is disposed in the gap. An antenna 10 having flexibility is disposed in the interior of the cover handle 7 as in a unitary body therewith. The antenna 10 is configured so as to flexibly deform inward with the cover handle 7 by that an operator grasps the cover handle 7.

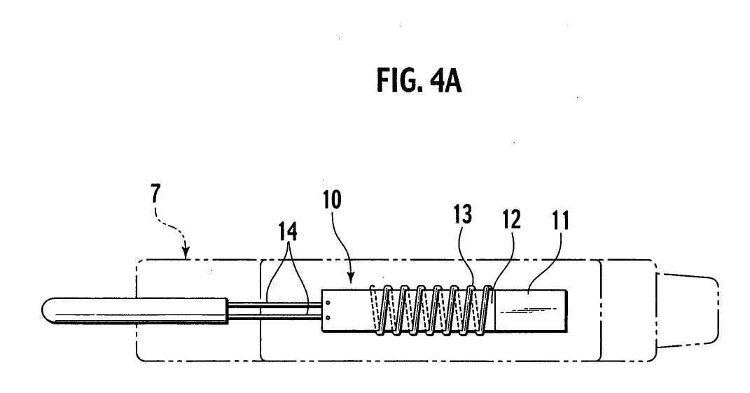

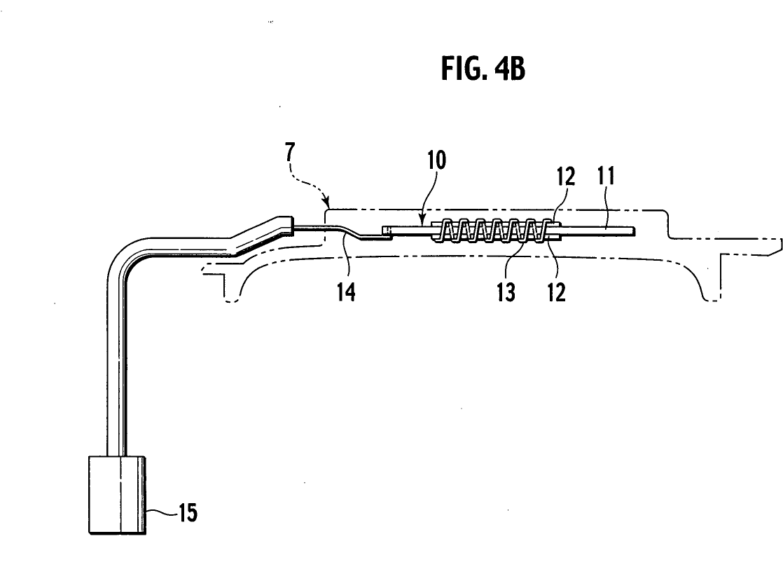

The antenna 10, as shown in FIGS. 4A and 4B, consists of a flexible printed board 11 and a body of a soft magnetic material and is provided with a pair of core portions 12 having soft magnetism respectively disposed on front and rear surfaces of the flexible printed board 11, an insulator-covered conductor 13 wound around an outer periphery of a flexible printed board 11 and the pair of the core portions 12, an electric cable 14 connected with the flexible printed board 11, and a connector 15 further connected to the electric cable 14.

Any material having flexibility and soft magnetism is preferably applied to the core portion 12. A commercially available material in a trade name of “Flex Suppressor” (TOKIN Corporation) may be exemplified.

The whole of the flexible printed board 11, the pair of the core portions 12 and the insulator-covered conductor 13 is sealed in the cover handle 7. Because the cover handle 7 is made of a resin having flexibility and the antenna 10 is structurally configured to have flexibility, the cover handle 7 easily deforms inward when the operator grasps the door handle 4.

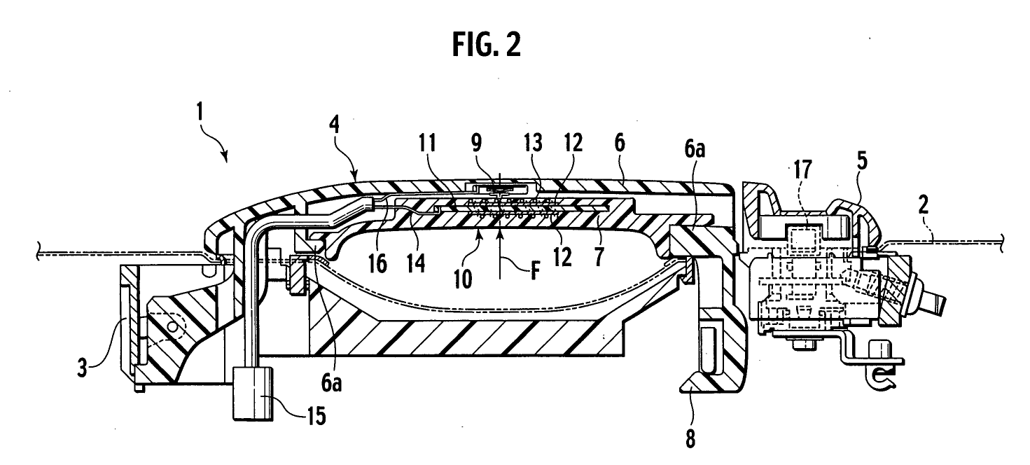

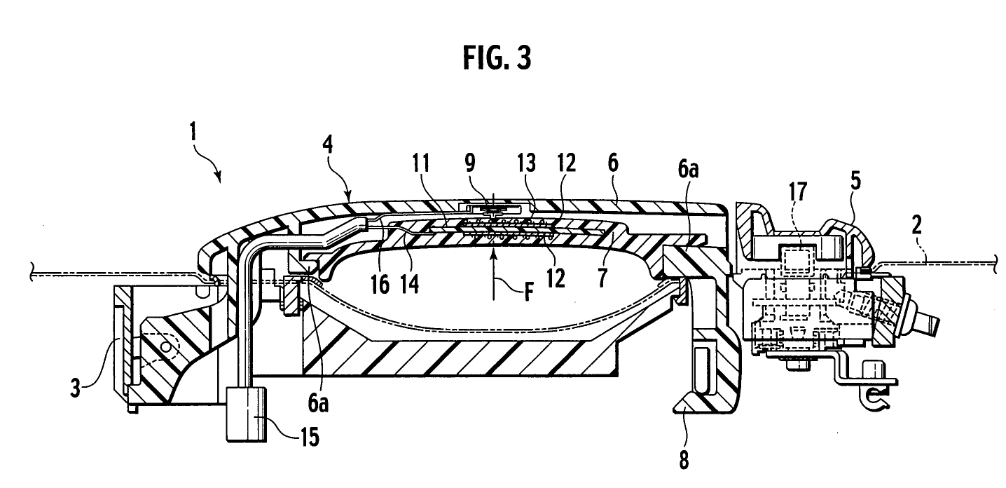

To the connector 15, as shown in FIGS. 2 and 3, the electric cable 16 in communication with the lock switch 9 is connected. Via the connector 15, the antenna 10 communicates with communication means (not shown) included in the vehicle body and the lock switch 9 communicates with control means (not shown).

The escutcheon 5 is provided with a cylinder-lock 17 capable of being operated by an auxiliary key (not shown). The cylinder-lock 17 is configured to lock/unlock the lock mechanism at a time of being operated by the auxiliary key.

The not-shown control means outputs a command for starting communication to the not-shown communication means at a time of receiving information outputted from the lock switch 9. When an ID signal is sent from the communication means, the ID signal is to be tested whether the ID signal corresponds with a predetermined ID signal. If they correspond, the locked/unlocked condition of the lock mechanism is changed. More specifically, the lock mechanism is controlled so that, when the lock mechanism is in the locked condition, the lock mechanism is made to be in the unlocked condition, and when the lock mechanismis in the unlocked condition, the lock mechanism is made to be in the locked condition.

The door open-close device 1 acts in the following manner. When the operator is going to get out of a vehicle and lock the door, he carries the portable device, goes out of vehicle, closes the door and grasps the door handle 4. Then, as shown in FIG. 3, the antenna 10 flexibly deforms by a force F with which the door handle 4 is grasped to operate the lock switch 9. When the lock switch 9 is operated, the communication means acts to transmit a communication radio wave from the antenna 10 and starts to communicate with the portable device. When the control means authenticates the portable device by the communication, the control means makes the lock means be in a locked condition. Thereby, one who does not carry the portable device cannot open the door even though he operates the door handle.

When the operator is going to get in the locked vehicle, he carries the portable device and gets a grip on the door handle. Then, as shown in FIG. 3, the antenna 10 flexibly deforms by a force F with which the door handle 4 is grasped to operate the lock switch 9. When the lock switch 9 is operated, the communication means acts to transmit a communication radio wave from the antenna 10 and starts to communicate with the portable device. When the control means authenticates the portable device by the communication, the control means makes the lock means be in a locked condition. When the operator grasps the door handle 4 and pulls the door to swing outward, the door is capable of opening.

As being understood from the above description, when the operator is going to get in the locked vehicle, he is required to do nothing but operate the door handle to open the door without using a key. As what the door handle 4 must have built in is only one lock switch 9, the number of parts with respect to the door handle 4 and accompanying parts such as the electric cable can be reduced. Because a space for housing them around the door handle 4 comes to be unnecessary, the parts around the door handle can be small-sized and the structure thereof and the cables can be simplified.

In accordance with the present embodiment, as the door handle 4 essentially consists of the handle main body 6 and the cover handle 7 and the antenna 10 is consisted in a unitary body with the cover handle 7, the number of parts relating to assembly work is relatively small and hence assembly can be carried out with facility. Further, since flexible deformation of the cover handle 7 is turned to advantage in installation of the cover handle 7 in the handle main body 6, the assembly can be carried out with greater facility.

Although the invention has been described above by reference to the embodiment of the invention, the invention is not limited to the embodiment described above. Modifications and variations of the embodiment described above will occur to those skilled in the art, in light of the above teachings. For example, the flexible printed board 11 can be omitted to construct the antenna 10 from only the core portions 12 and the insulator-covered conductor 13. One of the pair of the core portions 12 can be omitted. Alternatively, three or more core portions 12 can be installed in the antenna 10. A material for the cover handle 7 can be another resin or a rubber having flexibility instead of the elastomer. Further, the door open-close device 1 in accordance with the present embodiment is exemplified as an example to be applied to the door of the vehicle, however, it can be applied to a door of an entrance of a residence and such. In these modified examples, effects like as the effects described above can be obtained.

### INDUSTRIAL APPLICABILITY

A door open-close device capable of providing an operator with great convenience though the constitution is simple and compact is provided.

1. A door open-close device for control of a lock mechanism of a door by a circuit housed in a door handle, the door open-close device comprising:
a lock switch connected to an external circuit so as to control the external circuit; and
an antenna disposed to have a gap toward the lock switch and press down the lock switch at a time of deforming by being grasped by an operator, the antenna including a core portion of a soft magnetic material having flexibility and a conductor wound around the core portion, the conductor being connected to the external circuit so as to communicate with an external portable device.

2. The door open-close device of claim 1, wherein the antenna further including a cover handle configured to be installed in the door handle, the cover handle having the core portion and the conductor sealed in.
